(19) United States
(12) Patent Application Publication
(10) Pub. No.: US 2012/0315981 A1
(43) Pub. Date: Dec. 13, 2012

(54) SIMULTANEOUS GAME PLAY FOR WAGERING GAME SYSTEMS

(75) Inventors: Mark B. Gagner, West Chicago, IL (US); Timothy T. Gronkowski, Chicago, IL (US); Jacqueline F. Parra, Glen Ellyn, IL (US)

(73) Assignee: WMS GAMING, INC., Waukegan, IL (US)

(21) Appl. No.: 13/578,198

(22) PCT Filed: Feb. 11, 2011
(86) PCT No.: PCT/US11/24548

§ 371 Date: Aug. 9, 2012

Related U.S. Application Data
(60) Provisional application No. 61/304,146, filed on Feb. 12, 2010.

(51) Int. Cl. G06F 19/00; A63F 13/00; A63F 13/12; A63F 9/24

(52) U.S. Cl. 463/25; 463/29; 463/42; 463/43

(57) ABSTRACT

A wagering game system and its operations are described herein. In some embodiments, the operations can include initiating a wagering game session for a player in a first wagering game machine of the wagering game system based on a wagering game system account associated with the player. The operations can also include identifying wagering game machines of the wagering game system that are idle and available for simultaneous game play. The operations can further include initiating a wagering game session for the player in a second wagering game machine of the wagering game system for simultaneous game play. The second wagering game machine may be selected from the wagering game machines that are idle and available for simultaneous game play. The operations can further include initiating simultaneous game play in the first and second wagering game machines based on the players wagering game system account.

### RELATED APPLICATIONS

This application claims the priority benefit of U.S. Provisional Application Ser. No. 61/304,146 filed Feb. 12, 2010.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011, WMS Gaming, Inc.

### FIELD

Embodiments of the inventive subject matter relate generally to wagering game systems, and more particularly to simultaneous game play using two or more wagering game machines in a wagering game system.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### SUMMARY

In some embodiments, a computer-implemented method comprises: initiating a wagering game session for a player in a first wagering game machine of a wagering game system based on a wagering game system account associated with the player; determining whether to initiate simultaneous game play for the player in the wagering game system; identifying one or more wagering game machines of the wagering game system that are idle and available for simultaneous game play, in response to determining to initiate simultaneous game play for the player; initiating a wagering game session for the player in a second wagering game machine of the wagering game system for simultaneous game play, wherein the second wagering game machine is selected from the one or more wagering game machines that are idle and available for simultaneous game play; and initiating simultaneous game play in the first and second wagering game machines based on the player's wagering game system account.

In some embodiments, the method further comprises: determining results of the wagering games played during the wagering game sessions associated with the first and second wagering game machines during simultaneous game play; and updating the player's wagering game system account based on the results of the wagering games played during the wagering game sessions associated with the first and second wagering game machines during simultaneous game play.

In some embodiments, the method further comprises causing the first wagering game machine to present the results of the wagering games played during the wagering game sessions associated with the first and second wagering game machines during simultaneous game play.

In some embodiments, said identifying one or more wagering game machines of the wagering game system that are idle and available for simultaneous game play comprises: determining status information associated with each of the wagering game machines of the wagering game system; and identifying one or more wagering game machines of the wagering game system that are idle and available for simultaneous game play based, at least in part, on the status information associated with each of the wagering game machines of the wagering game system.

In some embodiments, said initiating the wagering game session for the player in the second wagering game machine for simultaneous game play comprises: determining that the player selected the second wagering game machine from the one or more wagering game machines that were identified as idle and available for simultaneous game play; verifying an identity of the player based, at least in part, on login information entered by the player; locking the second wagering game machine to prevent other players from gaining access to the second wagering game machine during simultaneous game play; and causing the second wagering game machine to present wagering game content to initiate the wagering game session in the second wagering game machine for simultaneous game play.

In some embodiments, the method further comprises, in addition to causing the first wagering game machine to present wagering game content for the wagering game session associated with the first wagering game machine, causing the first wagering game machine to present wagering game content for the wagering game session associated with the second wagering game machine for simultaneous game play.

In some embodiments, said initiating simultaneous game play in the first and second wagering game machines based on the player's wagering game system account comprises: obtaining account information associated with the player's wagering game system account; and associating both the wagering game session on the first wagering game machine and the wagering game session on the second wagering game machine to the player's wagering game system account during simultaneous game play.

In some embodiments, said associating both the wagering game session on the first wagering game machine and the wagering game session on the second wagering game machine to the player's wagering game system account during simultaneous game play comprises: coordinating deductions of wager amounts for the wagering games played that are associated with both the first and second wagering game machines from an account balance associated with the player's wagering game system account; and coordinating credits of win amounts for the wagering games played that are associated with both the first and second wagering game machines from the account balance associated with the player's wagering game system account.

In some embodiments, the method further comprises coordinating simultaneous game play in the first and second wagering game machines, wherein said coordinating simultaneous game play comprises: detecting input from the player to trigger a start of a round of a wagering game associated with the first wagering game machine; and causing the first wagering game machine to start the round of the wagering game associated with the first wagering game machine and simultaneously causing the second wagering game machine to start a round of a wagering game associated with the second wagering game machine.

In some embodiments, the method further comprises: determining when the player logs off the first wagering game machine; and ending the wagering game session associated with the first wagering game machine and the wagering game session associated with the second wagering game machine in response to determining that the player logs off the first wagering game machine.

In some embodiments, the method further comprises: determining whether a number of wagering game machines in the wagering game system that are idle and available for simultaneous game play is above a threshold that indicates whether sufficient idle wagering game machines are available for other players; allowing simultaneous game play if the number of wagering game machines that are idle and available for simultaneous game play is greater than the threshold; and preventing simultaneous game play if the number of wagering game machines that are idle and available for simultaneous game play is equal to or less than the threshold.

In some embodiments, the method further comprises: determining that a call attendant notification for a hand pay has been triggered at the first wagering game machine during simultaneous game play associated with the first wagering game machine and the second wagering game machine, wherein the second wagering game machine is located adjacent to the first wagering game machine; transferring the call attendant notification for the hand pay from the first wagering game machine to the second wagering game machine; causing the first wagering game machine and the second wagering game machine to pause the wagering game session associated with the second wagering game machine to wait for the hand pay; and allowing the first wagering game machine to continue the wagering game session associated with the first wagering game machine while the player waits for the hand pay.

In some embodiments, the method further comprises causing the first wagering game machine to present a map of the wagering game system indicating which of the wagering game machines in the wagering game system are idle and available for simultaneous game play, and a location of the wagering game machines within the wagering game system with respect to a location of the first wagering game machine.

In some embodiments, a wagering game server comprises: means for initiating a wagering game session for a player in a first wagering game machine of a wagering game system based on a wagering game system account associated with the player; means for determining that the player wants to initiate simultaneous game play in the wagering game system; means for identifying one or more wagering game machines of the wagering game system that are idle and available for simultaneous game play; means for initiating a wagering game session for the player in a second wagering game machine of the wagering game system for simultaneous game play, wherein the second wagering game machine is selected from the one or more wagering game machines that are idle and available for simultaneous game play; and means for initiating simultaneous game play in the first and second wagering game machines based on the player's wagering game system account.

In some embodiments, the wagering game server further comprises: means for determining results of the wagering games played during the wagering game sessions associated with the first and second wagering game machines during simultaneous game play; and means for updating the player's wagering game system account based on the results of the wagering games played during the wagering game sessions associated with the first and second wagering game machines during simultaneous game play.

In some embodiments, said means for initiating the wagering game session for the player in the second wagering game machine for simultaneous game play comprises: means for determining that the player selected the second wagering game machine from the one or more wagering game machines that were identified as idle and available for simultaneous game play; means for verifying an identity of the player based, at least in part, on login information entered by the player; means for locking the second wagering game machine to prevent other players from gaining access to the second wagering game machine during simultaneous game play; means for causing the second wagering game machine to present wagering game content to initiate the wagering game session in the second wagering game machine for simultaneous game play; and means for causing the first wagering game machine to present wagering game content for the wagering game session associated with the first wagering game machine and present wagering game content for the wagering game session associated with the second wagering game machine for simultaneous game play.

In some embodiments, a computer-implemented method comprises: initiating a wagering game session for a player in a first wagering game machine of a wagering game system based on a wagering game system account associated with the player; determining that the player wants to remotely reserve at least one wagering game machine of the wagering game system; identifying one or more wagering game machines of the wagering game system that are idle and available to be reserved; determining that the player wants to remotely reserve a second wagering game machine selected by the player from the one or more wagering game machines of the wagering game system that are idle and available to be reserved; reserving the second wagering game machine for the player; and starting a timer providing the player a predefined amount of time to log in to the second wagering game machine that is reserved for the player.

In some embodiments, the method further comprises: determining whether the player logs in to the second wagering game machine that is reserved for the player before the predefined amount of time associated with the timer expires; initiating a wagering game session for the player at the second wagering game machine based on the player's wagering game system account if the player logs in before the predefined amount of time associated with the time expires; and changing a status of the second wagering game machine from reserved to available to allow other players to log in to the second wagering game machine if the player does not log in before the predefined amount of time associated with the time expires.

In some embodiments, the method further comprises causing the first wagering game machine to present a map of the wagering game system indicating which of the wagering game machines in the wagering game system are idle and available to be reserved, and a location of the wagering game machines within the wagering game system with respect to a location of the first wagering game machine.

In some embodiments, a wagering game system comprises: a first wagering game machine; a second wagering game machine; and a wagering game server coupled to the first and second wagering game machines via a communications network. The wagering game server is configured to initiate a wagering game session for a player in the first wagering game machine based on a wagering game system account associated with the player and configured to: determine whether to initiate simultaneous game play for the player in the wagering game system; identify one or more wagering game machines of the wagering game system that are idle and available for simultaneous game play, in response to determining to initiate simultaneous game play for the player; initiate a wagering game session for the player in the second wagering game machine for simultaneous game play, wherein the second wagering game machine is selected from the one or more wagering game machines that are idle and available for simultaneous game play; and initiate simultaneous game play in the first and second wagering game machines based on the player's wagering game system account. During simultaneous game play, the first wagering game machine is configured to present game content for wagering games played during the wagering game session associated with the first wagering game machine, and present wagering game content for wagering games played during the wagering game session associated with the second wagering game machine. During simultaneous game play, the second wagering game machine is configured to present game content for wagering games played during the wagering game session associated with the second wagering game machine.

In some embodiments, the wagering game server is further configured to: determine results of the wagering games played during the wagering game sessions associated with the first and second wagering game machines during simultaneous game play; and update the player's wagering game system account based on the results of the wagering games played during the wagering game sessions associated with the first and second wagering game machines during simultaneous game play.

In some embodiments, the wagering game server configured to initiate simultaneous game play in the first and second wagering game machines based on the player's wagering game system account comprises the wagering game server configured to: obtain account information associated with the player's wagering game system account; and associate both the wagering game session on the first wagering game machine and the wagering game session on the second wagering game machine to the player's wagering game system account during simultaneous game play.

In some embodiments, one or more machine-readable storage media, having instructions stored therein, which, when executed by one or more processors causes the one or more processors to perform operations that comprise: initiating a wagering game session for a player in a first wagering game machine of a wagering game system based on a wagering game system account associated with the player; determining that the player wants to initiate simultaneous game play in the wagering game system based, at least in part, on an indication received from the first wagering game machine indicating that the player wants to initiate simultaneous game play; identifying one or more wagering game machines of the wagering game system that are idle and available for simultaneous game play; initiating a wagering game session for the player in a second wagering game machine for simultaneous game play, in response to receiving an indication from the first wagering game machine that the player selected the second wagering game machine from the one or more wagering game machines that are idle and available for simultaneous game play; and initiating simultaneous game play in the first and second wagering game machines based on the player's wagering game system account.

In some embodiments, the instructions when executed by one or more processors causes the one or more processors to perform operations that further comprise: determining results of the wagering games played during the wagering game sessions associated with the first and second wagering game machines during simultaneous game play; and updating the player's wagering game system account based on the results of the wagering games played during the wagering game sessions associated with the first and second wagering game machines during simultaneous game play.

In some embodiments, the operation for initiating the wagering game session for the player in the second wagering game machine for simultaneous game play includes operations further comprising: determining that the player selected the second wagering game machine from the one or more wagering game machines that were identified as idle and available for simultaneous game play; verifying an identity of the player based, at least in part, on login information entered by the player; locking the second wagering game machine to prevent other players from gaining access to the second wagering game machine during simultaneous game play; causing the second wagering game machine to present wagering game content to initiate the wagering game session at the second wagering game machine for simultaneous game play; and causing the first wagering game machine to present wagering game content for the wagering game session associated with the first wagering game machine and present wagering game content for the wagering game session associated with the second wagering game machine for simultaneous game play.

### BRIEF DESCRIPTION OF THE FIGURES

Embodiments are illustrated in the Figures of the accompanying drawings in which:

FIG. 1 is a conceptual diagram illustrating an example of implementing simultaneous game play in two or more wagering game machines of a wagering game system, according to some embodiments;

FIG. 2 is a conceptual diagram that illustrates an example of a wagering game system architecture, according to some embodiments;

FIG. 3 is a flow diagram illustrating operations of a wagering game server for implementing simultaneous game play in two or more wagering game machines of a wagering game system, according to some embodiments;

FIG. 4 is a flow diagram illustrating additional operations of a wagering game server for implementing simultaneous game play in two or more wagering game machines of a wagering game system, according to some embodiments;

FIG. 5 is a flow diagram illustrating operations for remote reservation of one or more wagering game machines in a wagering game system, according to some embodiments;

FIG. 6 is a conceptual diagram that illustrates an example of a wagering game machine architecture, according to some embodiments; and

FIG. 7 is a perspective view of a wagering game machine, according to example embodiments.

### DESCRIPTION OF THE EMBODIMENTS

This description of the embodiments is divided into five sections. The first section provides an introduction to some embodiments, while the second section describes example wagering game machine architectures. The third section describes example operations performed by some embodiments and the fourth section describes example wagering game machines in more detail. The fifth section presents some general comments.

### Introduction

This section provides an introduction to some embodiments.

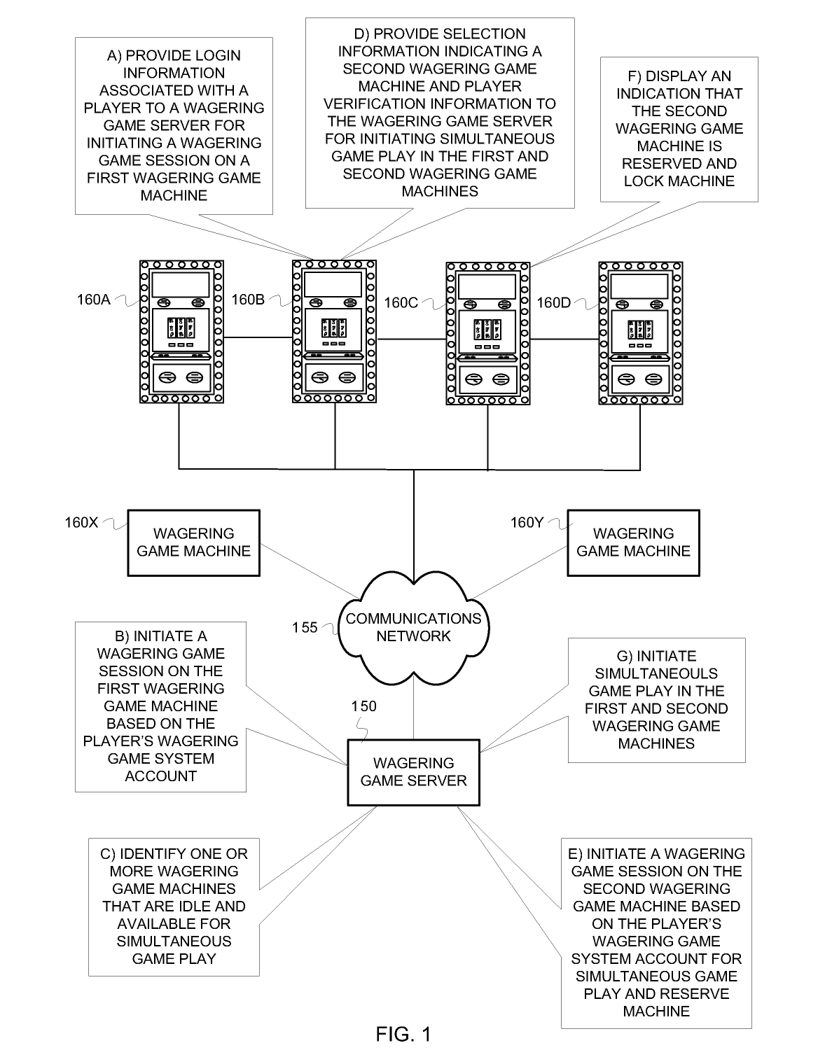

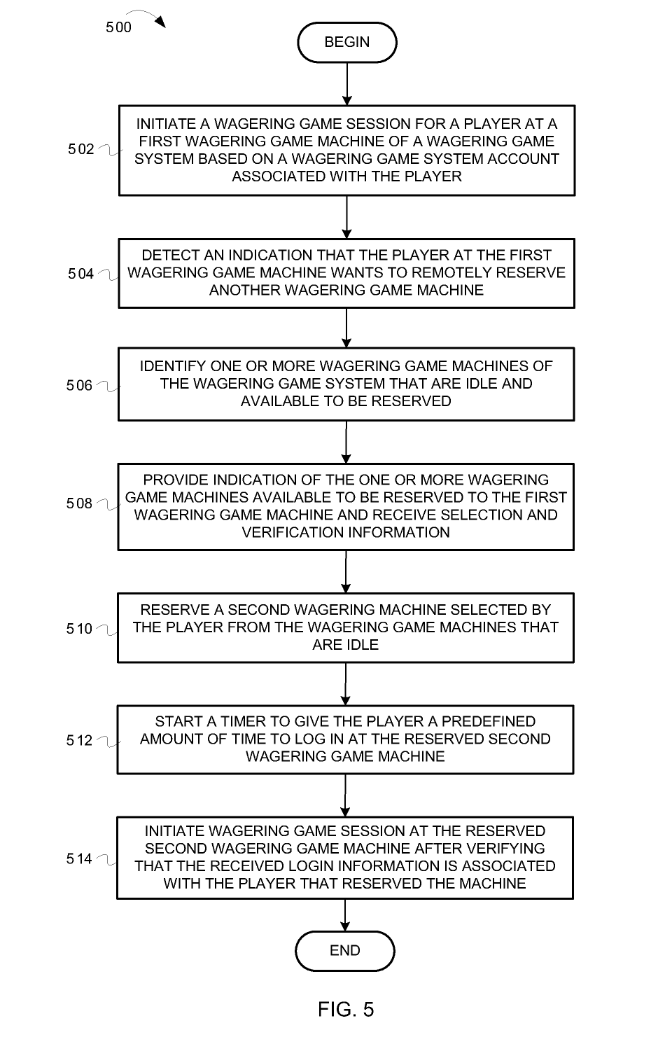

Wagering game systems offer wagering game players (“players”) entertainment value and the opportunity to win monetary value. Wagering game systems can try to enhance the gaming experience by offering players the option to simultaneously play on two or more wagering game machines from a single wagering game machine (“simultaneous game play”). In one embodiment, the wagering game system allows a player playing games at a first wagering game machine to simultaneously play games of one or more additional wagering game machine remotely from the first wagering game machine, as will be further described below with reference to FIGS. 1-4. In one example, when a player initiates simultaneous game play at two wagering game machines using the player's wagering game system account, the player's input during the wagering game session at the first wagering game machine can be applied also to the wagering game session at the second wagering game machine for synchronized game play. For example, if the player presses the spin button to spin the reels of a slots game at the first wagering game machines, this will also spin the reels of the slots game at the second wagering game machine. In another example, if the player initiates simultaneous game play on two adjacent wagering game machines, the wagering game displayed on the first wagering game machine can be extended to include the game content displayed on the second wagering game machine. For example, two 5 reel slots games displayed at the two adjacent machines can be extended across the two adjacent machines to allow the player to play a 10 reel slots game. In one embodiment, the wagering game system can also allow a player playing at a first wagering game machine to remotely reserve a second wagering game machine (e.g., if the player wants to move to a different type of wagering game machine or a different section of the casino), as will be further described below with reference to FIG. 5. In another example, when a player has initiated simultaneous game play at two or more wagering game machines, the wagering game system can allow the player to reserve two or more different wagering game machines and transfer the wagering game sessions to the reserved wagering game machines.

FIG. 1 is a conceptual diagram illustrating an example of implementing simultaneous game play in two or more wagering game machines of a wagering game system, according to some embodiments. In the example shown in FIG. 1, the wagering game system (“system”) 100 includes a wagering game server 150 connected to a plurality of wagering game machines 160 via a communications network 155. As illustrated, in one example, the plurality of wagering game machines 160 can include wagering game machines 160A-160D, which are adjacent to one another in a casino, and also wagering game machines 160X and 160Y in different sections of the casino.

At stage A, a first wagering game machine (i.e., the wagering game machine 160B) provides login information associated with a player to the wagering game server 150 for initiating a wagering game session on the wagering game machine 160B. In one example, the player inserts a player account card into a card reader of the wagering game machine 160B. The wagering game machine 160B retrieves the login information (e.g., wagering game system account number, player ID number, and/or passwords) from the player account card. The wagering game machine 160B provides the login information to the wagering game server 150 via the communications network 155. It is noted, however, that in other examples the player can provide login information to a wagering game machine by other techniques, e.g., a biometric input, an RFID input, a touchscreen input, etc.

At stage B, the wagering game server 150 initiates a wagering game session on the wagering game machine 160B based on the player's wagering game system account derived from the login information received from the wagering game machine 160B. For example, the wagering game server 150 provides the player's account balance, player preferences information, and other game content and player information to the wagering game machine 160B to initiate the wagering game session on the wagering game machine 160B.

At stage C, the wagering game server 150 identifies one or more wagering game machines 160 in the wagering game system 100 that are idle and available for simultaneous game play. In one example, the wagering game server 150 can periodically request a status from all of the wagering game machines 160 in the system 100 to keep track of which wagering game machines are occupied by players (i.e., being used by players to play wagering games), idle and available for game play, or not operational (i.e., out of service). In another example, the wagering game machines 160 are configured to periodically provide status information to the wagering game server 150, or provide status updates to the wagering game server 150 when there is a status change (e.g., when the status changes from “active” or “occupied” to “idle” or “available”). In another example, to determine which wagering game machines 160 are occupied by players, the wagering game server 150 can keep track of which wagering game machines 160 in the system 100 have provided login information to initiate a wagering game session and have not logged out. The wagering game server 150 can also keep track of which wagering game machines 160 are not operational and have service requests pending. Furthermore, the wagering game server 150 can determine which of the wagering game machines 160 that are idle have the capabilities for simultaneous game play; for example, the wagering game server 150 can determine which of the idle wagering game machines have remote login and reservation capabilities and account based wagering capabilities, as will be further described below.

At the same time, or prior to, determining which wagering game machines are idle and available for simultaneous game play, the wagering game server 150 can determine whether the player wants to initiate simultaneous game play at the wagering game machine 160B. In one example, after the player logs in to the wagering game machine 160B, the wagering game server 150 can cause the wagering game machine 160B to request input from the player indicating whether or not the player wants to initiate simultaneous game play. For example, a window can be presented to the player providing information about simultaneous game play and asking the player whether or not the player wants to participate. The wagering game machine 160B detects input from the player indicating whether or not the player wants to initiate simultaneous game play at the wagering game machine 160B, and provides an indication to the wagering game server 150 that the player wants to initiate simultaneous game play. It is noted, however, that in other examples the wagering game system will only request input from the player regarding simultaneous game play if the player selects the simultaneous game play option from the game menus on the wagering game machine, if the player's account preferences and/or account history indicate that the player enjoys simultaneous game play, or if the player clicks on an advertisement, icon, or other notification associated with simultaneous game play that is displayed on the wagering game machine.

If the player indicates that the player wants to initiate simultaneous game play, the wagering game server 150 provides information to the wagering game machine 160B indicating which wagering game machines 160 in the system 100 are idle and available for simultaneous game play. The wagering game server 150 can also provide other information about the wagering game machines 160 that are idle and available for simultaneous game play; e.g., the wagering game server 150 can indicate the location of the idle wagering game machines within the casino, the games available at each idle wagering game machine, etc. In one example, the wagering game server 150 can provide a map of the casino floor indicating which of the wagering game machines 160 are idle and the location of the idle wagering game machines from the player's current location. In some examples, simultaneous game play can be limited to idle wagering game machines that are adjacent to, or in close proximity to, the wagering game machine 160B.

At stage D, the wagering game machine 160B provides selection information indicating a second wagering game machine (i.e., the wagering game machine 160C) and player verification information to the wagering game server 150 for initiating simultaneous game play in the wagering game machines 160B and 160C. In one example, the wagering game machine 160B can receive the map of the casino floor indicating which of the wagering game machines 160 in the system 100 are idle and available for simultaneous game play, and the wagering game machine 160B can present the map to the player on a display of the wagering game machine 160B. The player can select (e.g., via a touchscreen input) which of the idle wagering game machines the player wants to reserve for simultaneous game play. In some examples, after the player selects one of the idle wagering game machines (e.g., wagering game machine 160C), the wagering game machine 160B can request that the player enters verification information (e.g., login information, account number, player ID number, or password) to initiate simultaneous game play. The wagering game machine 160B can then provide selection information and player verification information to the wagering game server 150. In some examples, if the selected wagering game machine (e.g., wagering game machine 160C) is adjacent or in close proximity to the wagering game machine 160B, the wagering game server 150 can cause a verification screen to be presented on the selected wagering game machine to request verification information from the player.

At stage E, the wagering game server 150 can initiate a wagering game session on the wagering game machine 160C (i.e., the selected wagering game machine) based on the player's wagering game system account for simultaneous game play from the wagering game machine 160B. For example, the wagering game server 150 provides player preferences information and game content information to the wagering game machine 160C to initiate the wagering game session. At the same time, the wagering game server 150 can reserve the wagering game machine 160C for the player to prepare to initiate simultaneous game play. For example, to reserve the wagering game machine 160C, the wagering game server 150 can cause the wagering game machine 160C to display a “reserved” status message and/or deactivates or locks the control panel, touchscreen, and other input devices of the wagering game machine 160C (e.g., buttons, joystick, card reader, etc.).

At stage F, in response to receiving instructions from the wagering game server 150, the wagering game machine 160C displays an indication that the wagering game machine 160C is reserved and locks the input devices of the wagering game machine 160C. For example, the wagering game machine 160C displays a “reserved” status message and deactivates or locks the control panel, touchscreen, and other input devices of the wagering game machine 160C (e.g., buttons, joystick, card reader, etc.). It is noted, however, that the wagering game machine 160C can provide other indications that the machine is reserved, e.g., remove the game menus from the display, dim or turn off the lights of the machine, etc. In some embodiments, even though the wagering game machine 160C provides various indications that the machine is reserved, the wagering games that are played can still be displayed on the wagering game machine 160C. The one or more indications that the wagering game machine 160C is reserved prevents another player from disrupting simultaneous game play by attempting to log in to the wagering game machine 160C or by providing other types of inputs, and also prevents another player from claiming a prize won on the wagering game machine 160C during simultaneous game play.

At stage G, the wagering game server 150 initiates simultaneous game play in the wagering game machines 160B and 160C based on the player's wagering game system account. In one embodiment, when the wagering game machine 160C is adjacent to, or in close proximity to, the wagering game machine 160B (i.e., the location of the player), the wagering game machine 160B can present a first wagering game (e.g., a video slots game) on the display of the wagering game machine 160B, and a second wagering game (e.g., another video slots game) on the display of the wagering game machine 160C. The player can then begin simultaneous game play, i.e., play both the first wagering game and the second wagering game from the wagering game machine 160B. For example, the player input detected from the player for the first wagering game at wagering game machine 160B can also be applied to the second wagering game associated with the wagering game machine 160C for synchronized game play. In one example, if the player presses the spin button at the wagering game machine 160B to spin the reels of a slots game, this will also spin the reels of a slots game being displayed at the wagering game machine 160C. In another example, instead of synchronized game play, the wagering game machine 160B can present a control panel on the display of the wagering game machine 160B that separately controls the second wagering game on the wagering game machine 160C. In some examples, when the reserved wagering game machine is not in close proximity to the wagering game machine 160B (e.g., wagering game machine 160X), the wagering game machine 160B can present a window within one of the displays of the wagering game machine 160B to display the second wagering game associated with the wagering game machine 160X being played during simultaneous game play. In some embodiments, if the player initiates simultaneous game play on two adjacent wagering game machines 160B and 160C, the wagering game displayed on the wagering game machine 160B can be extended to include the game content displayed on the second wagering game machine 160C. For example, two 5 reel slots games displayed at the two adjacent wagering game machines 160B and 160C can be extended across the two adjacent machines to allow the player to play a 10 reel slots game. The wager amounts and the win amounts for both the first and second wagering games can be deducted from and added to, respectively, the account balance associated with the player's wagering game system account.

In some embodiments, in addition to offering simultaneous game play, the wagering game server 150 can allow the player at the wagering game machine 160B to remotely reserve another wagering game machine (e.g., wagering game machine 160X), as will be further described below with reference to FIG. 5. For example, the wagering game server 150 can allow the player at the wagering game machine 160B to remotely reserve the wagering game machine 160X or 160Y to move to a different section of the casino, or to try different wagering games only available in certain machines in the casino, etc. In another example, when a player has initiated simultaneous game play at two or more wagering game machines (e.g., 160B and 160C), the wagering game server 150 can allow the player to remotely reserve two or more different wagering game machines (e.g., 160X and 160Y) if the player wants to move to different machines or to a different section of the casino. In some embodiments, in addition to reserving the wagering game machines, the wagering game server 150 can allow the player to transfer the wagering game sessions associated with simultaneous game play to the reserved wagering game machines so that the player can continue the current wagering game sessions at the reserved wagering game machines. In some examples, to transfer the wagering game sessions, the wagering game server 150 can transfer the game configurations, game content, simultaneous game play configurations and status, and other game or player related information associated with the current wagering game sessions to the reserved wagering game machines. This can allow players to try playing at other wagering game machines in the casino without disrupting the wagering game session. This can also allow players to avoid nuisances in the casino (e.g., a person that sits down in an adjacent machine that is smoking) without disrupting the wagering game session. In another example, if a call attendant for a hand pay is triggered at the wagering game machine 160B, the player can transfer the call attendant for the hand pay to the adjacent wagering game machine 160C (if available), and continue playing on the wagering game machine 160B. It is noted that other applications of the mechanism for simultaneous game play and remote reservation of wagering game machines can be implemented in the wagering game system 100, as will be further described below.

In some embodiments, the wagering game server 150 can allow a player to initiate simultaneous game play at the wagering game machine 160B based on money deposited at the wagering game machine 160B (e.g., via a ticket, cash, debit card, etc.). In other words, instead of initiating simultaneous game play based on account based wagering capabilities, the wagering game server 150 can initiate simultaneous game play based on a monetary deposit at the wagering game machine 160B.

Although FIG. 1 describes some embodiments, the following sections describe many other features and embodiments.

### Operating Environment

This section describes example operating environments and networks and presents structural aspects of some embodiments. More specifically, this section includes discussion about wagering game system architectures.

### Wagering Game System Architectures

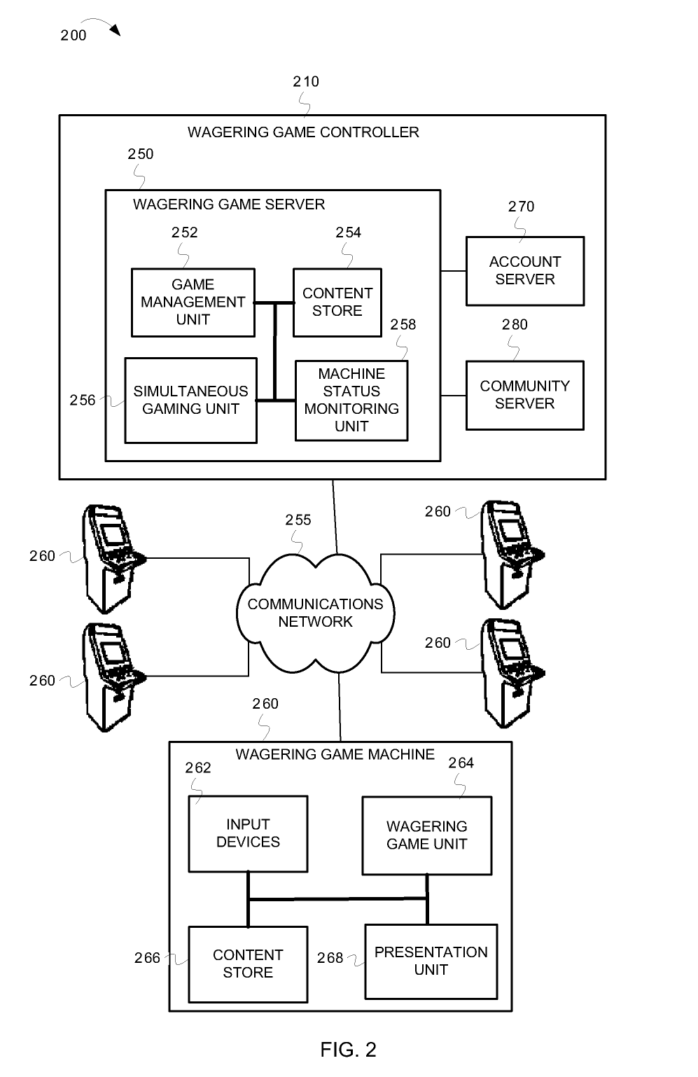

FIG. 2 is a conceptual diagram that illustrates an example of a wagering game system architecture 200, according to some embodiments. As illustrated, the wagering game system architecture 200 includes a wagering game controller 210 and a plurality of wagering game machines 260. The wagering game controller 210 is configured to control game content (e.g., game elements, game customization options, game updates, game results, etc.) and communicate game-related information and other information (e.g., social networking services) to and from the plurality of wagering game machines 260. In one example, the wagering game controller 210 includes a wagering game server 250, an account server 270, and a community server 280.

The wagering game server 250 is configured to manage and control content for presentation on the wagering game machines 260. As illustrated, in some embodiments, the wagering game server 250 includes a game management unit 252 configured to provide (e.g., stream) game content and other game-related information to the wagering game machines 260. The game management unit 252 is configured to generate (e.g., using a random numbers generator) game results (e.g., win/loss values), including win amounts, for wagering games played on the wagering game machines 260. The game management unit 252 can communicate the game results to the wagering game machines 260 via the network 255. In some embodiments, the game management unit 252 can also generate random numbers and provide them to the wagering game machines 260 so that the wagering game machines 260 can generate game results. The wagering game server 250 can also include a content store 254 configured to store content used for presenting wagering games (e.g., base wagering games, secondary bonus games, etc.) and other game-related information associated with wagering game presented on the wagering game machines 260. The wagering game server 250 can also include a machine status monitoring unit 258 configured to detect wagering game machines 260 in the casino that are idle and available for simultaneous game play and/or remote reservation. The wagering game server 250 can further include a simultaneous gaming unit 256 configured to initiate simultaneous game play for a player in two or more of the wagering game machines 260 and also configured to remotely reserve a wagering game machine for a player, as described herein with reference to FIGS. 1-5.

The account server 270 is configured to control player-related accounts accessible via the wagering game system 200. The account server 270 can manage player financial accounts (e.g., performing funds transfers, deposits, withdrawals, etc.) and player information (e.g., avatars, screen name, account identification numbers, social contacts, financial information, etc.). The account server 270 can also provide auditing capabilities, according to regulatory rules, and track the performance of players, machines, and servers. The account server 270 can include an account controller configured to control information for the player accounts. The account server 270 can also include an account store configured to store information for the player accounts.

The community server 280 is configured to provide a wide range of services to members of virtual gaming communities. For example, the community servers may allow players to:

Create Social Networks—When creating social networks, members can create electronic associations that inform network members when selected members are: 1) online, 2) performing activities, 3) reaching milestones, 4) etc.

Establish a Reputation—Community members can establish reputations based on feedback from other community members, based on accomplishments in the community, based on who is in their social network, etc.

Provide Content—Community members can provide content by uploading media, designing wagering games, maintaining blogs, etc.

Filter Content—Community members can filter content by rating content, commenting on content, or otherwise distinguishing content.

Interact with Other Members—Community members can interact via newsgroups, e-mail, discussion boards, instant messaging, etc.

Participate in Community Activities—Community members can participate in community activities, such as multi-player games, interactive meetings, discussion groups, real-life meetings, etc.

Connect Casino Players to Online Members—Community members who are playing in casinos can interact with members who are online. For example, online members may be able to: see activities of social contacts in the casino, chat with casino players, participate in community games involving casino players, etc.

In some embodiments, the community server 280 enables online community members (e.g., operating a personal computer (PC) or a mobile device) to participate in and/or monitor wagering games that are being presented in one or more casinos. The community server 280 can enable community members to connect with and track each other. For example, the community server 280 can enable community members to select other members to be part of a social network. The community server 280 can also enable members of a social network to track what other social network members are doing in a virtual gaming community and a real-world casino. For example, in some implementations, the community server 280 assists in enabling members of a social network to see when network members are playing wagering game tables and machines in a casino, accessing a virtual gaming community web site, achieving milestones (e.g., winning large wagers in a casino), etc.

The community server 280 can store and manage content for a virtual gaming community. For example, in some embodiments, the community server 280 can host a web site for a virtual gaming community. Additionally, the community server 280 can enable community members and administrators to add, delete, and/or modify content for virtual gaming communities. For example, the community server 280 can enable community members to post media files, member-designed games, commentaries, etc., all for consumption by members of a virtual gaming community.

The community server 280 can track behavior of community members. In some embodiments, the community server 280 tracks how individuals and/or groups use the services and content available in a virtual gaming community. The community server 280 can analyze member behavior and categorize community members based on their behavior. The community server 280 can configure network components to customize content based on individual and/or group habits.

The community server 280 can manage various promotions offered to members of a virtual gaming community. For example, the promotions community server 280 can distribute promotional material when members achieve certain accomplishments (e.g., scores for online games) in a virtual gaming community. Members may use some of the promotional material when playing wagering games in a casino.

The wagering game machines 260 are configured to present wagering games and receive and transmit information to control the content that is presented for the wagering games. The wagering game machines 260 can include input devices 262, a wagering game unit 264, a content store 266, and a presentation unit 268. The input devices 262 may include buttons, joysticks, touch screens, cameras, etc., used to detect player input associated with wagering games. The wagering game unit 264 is configured to manage and control the game content that is presented on the wagering game machine 260. The wagering game unit 264 can also work in conjunction with the wagering game server 250 to implement simultaneous game play and remote reservation for the wagering game machine 260, as described herein with reference to FIGS. 1 and 3-5. Furthermore, the wagering game unit 264 can generate game results based on random numbers received from the wagering game server 250, or may communicate with the wagering game server 250 to obtain the game results. The content store 266 is configured to store content that is presented on the wagering game machine 260. The presentation unit 268 is configured to control the presentation of the game content on the wagering game machine 260. The presentation unit 268 can include one or more browsers and any other software and/or hardware suitable for presenting audio and video content. It is noted, however, that in other implementations the game content can be presented using other display technologies.

The wagering game machines described herein (e.g., wagering game machines 260) can take any suitable form, such as floor standing models, handheld mobile units, bar-top models, workstation-type console models, surface computing machines, etc. Further, wagering game machines can be primarily dedicated for use in conducting wagering games, or can include non-dedicated devices, such as personal computers (PC), mobile phones, personal digital assistants (PDAs), laptop computers, etc. For example, the non-dedicated devices can provide players access to wagering games via a wireless network within a physical casino, or remotely via the Internet.

In some embodiments, each of the wagering game machines 260 and the wagering game server 250 are configured to work together such that the wagering game machine 260 can be operated as a thin, thick, or intermediate client. For example, one or more elements of game play may be controlled by the wagering game machine 260 (client) or the wagering game server 250 (server). Game play elements can include executable game code, lookup tables, configuration files, game results, audio or visual representations of the game, game assets or the like. In a thin-client example, the wagering game server 250 can perform functions such as determining game results or managing assets, while the wagering game machine 260 can present a audible/graphical representation of such outcome or asset modification to the players. In a thick-client example, the wagering game machine 260 can determine game outcomes and communicate the outcomes to the wagering game server 250 for recording or managing a player's account.

In some embodiments, either the wagering game machines (client) or the wagering game server(s) can provide functionality that is not directly related to game play. For example, account transactions and account rules may be managed centrally (e.g., by the wagering game server(s)) or locally (e.g., by the wagering game machines). Other functionality not directly related to game play may include power management, presentation of advertising, software or firmware updates, system quality or security checks, etc.

Each component shown in the wagering game system architecture 200 is shown as a separate and distinct element connected via a communications network 255. However, some functions performed by one component could be performed by other components. For example, the wagering game server 250 can be configured to perform some or all of the functions of the account server 270, and/or the game management unit 252 can be configured to perform some or all of the functions of the simultaneous gaming unit 256 and the machine status monitoring unit 258. Furthermore, the components shown may all be contained in one device, but some, or all, may be included in, or performed by multiple devices, as in the configurations shown in FIG. 2 or other configurations not shown, e.g., the simultaneous gaming unit 256 can be distributed across the wagering game server 250 and the wagering game machines 260. Furthermore, the wagering game system architecture 200 can be implemented as software, hardware, any combination thereof, or other forms of embodiments not listed. For example, any of the network components (e.g., the wagering game tables, machines, servers, etc.) can include hardware and machine-readable media including instructions for performing the operations described herein. Machine-readable media includes any mechanism that provides (i.e., stores and/or transmits) information in a form readable by a machine (e.g., a wagering game table, machine, computer, etc.). For example, tangible machine-readable storage media includes read only memory (ROM), random access memory (RAM), magnetic disk storage media, optical storage media, flash memory machines, and/or other types of tangible storage medium suitable for storing instructions. Machine-readable transmission media includes any media suitable for transmitting software over a network.

Although FIG. 2 describes some embodiments, the following sections describe many other features and embodiments.

### Example Operations

This section describes operations associated with some embodiments. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

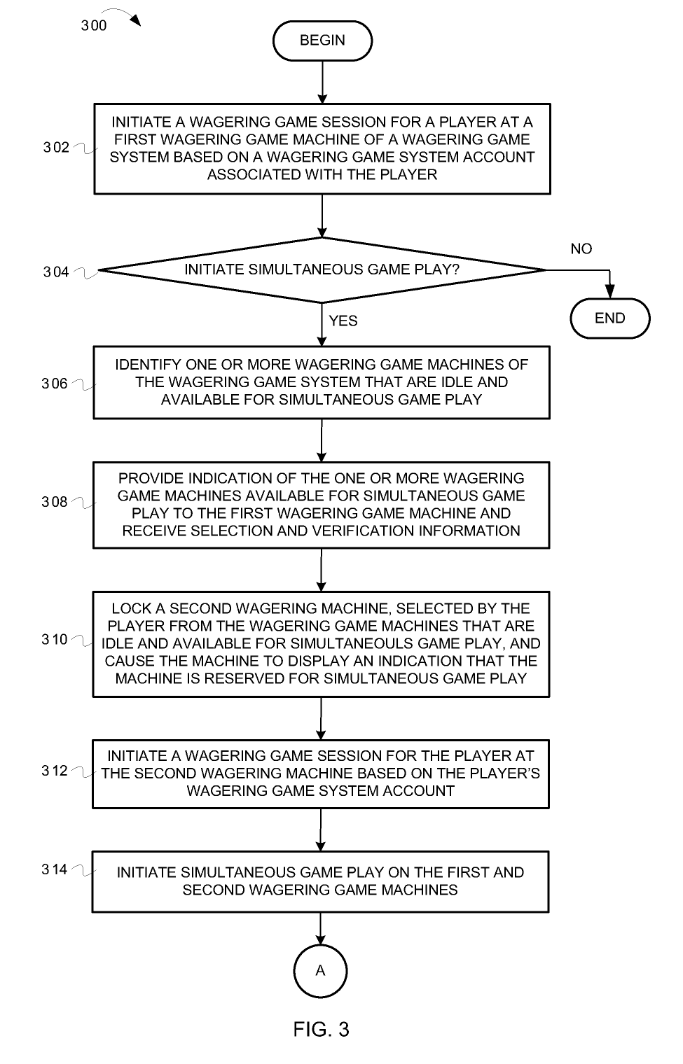

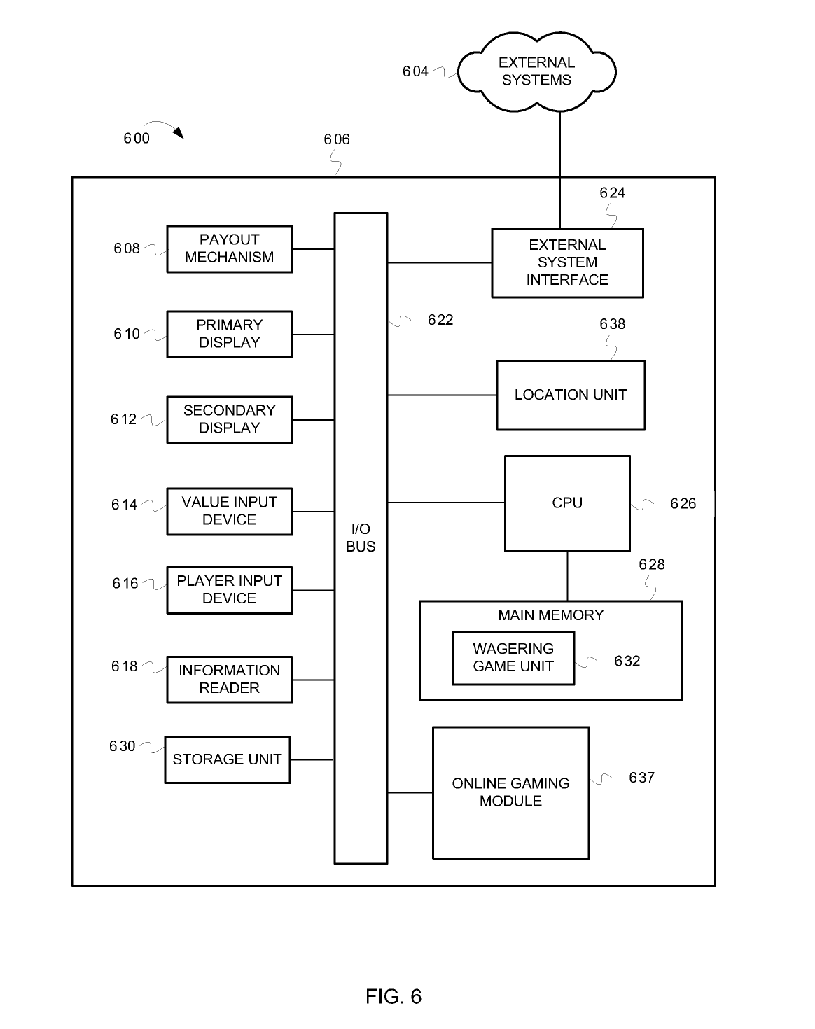

The following discussion of FIGS. 3-5 describes example mechanisms for implementing simultaneous game play in a wagering game system. FIG. 6 describes an example mechanism for remotely reserving one or more wagering game machines in a wagering game system.

FIG. 3 is a flow diagram (“flow”) 300 illustrating operations of a wagering game server for implementing simultaneous game play in two or more wagering game machines of a wagering game system, according to some embodiments. The flow of 300 will be described with reference to the example system architecture of FIG. 2. The flow diagram begins at block 302.

At block 302, the wagering game server 250 initiates a wagering game session for a player at a first wagering game machine 260 of the wagering game system 200 based on a wagering game system account associated with the player. In one embodiment, the wagering game server 250 receives login information (e.g., wagering game system account number, player ID number, and/or passwords) from the first wagering game machine 260, as was described above with reference to FIG. 1. The game management unit 252 of the wagering game server 250 accesses the account server 270 to determine the wagering game system account associated with the player based on the login information received from the first wagering game machine 260. In one example, the game management unit 252 provides the player's account balance, player preferences information, and other game content and player information to the first wagering game machine 260 to initiates the wagering game session on the first wagering game machine 260. After block 302, the flow continues at block 304.

At block 304, the wagering game server 250 determines whether to the player wants to initiate simultaneous game play on two or more wagering game machines. In one example, after the player logs in to the first wagering game machine 260 and the wagering game session is initiated, the simultaneous gaming unit 256 of the wagering game server 250 can cause the first wagering game machine 260 to request input from the player to determine whether or not the player wants to initiate simultaneous game play. For example, as described in FIG. 1, a window can be presented to the player providing information about simultaneous game play and asking the player whether or not the player wants to participate. In other examples, the simultaneous gaming unit 256 will only request input from the player regarding simultaneous game play if the player selects the simultaneous game play option from the game menus on the first wagering game machine 260, if the player's account preferences and/or account history indicate that the player enjoys simultaneous game play, or if the player clicks on an advertisement, icon, or other notification associated with simultaneous game play that is displayed on the first wagering game machine 260. If the simultaneous gaming unit 256 determines that the player wants to initiate simultaneous game play, the flow continues at block 306. Otherwise, the player continues with the wagering game session at the first wagering game machine 260, and the simultaneous game play initiation process ends. It is noted, however, that at any point in time during the wagering game session the player can select a simultaneous game play option (e.g., via a game menu, icon, etc.) to initiate simultaneous game play from the first wagering game machine 260.

At block 306, the wagering game server 250 identifies one or more wagering game machines 260 in the wagering game system 200 that are idle and available for simultaneous game play. In one example, the machine status monitoring unit 258 of the wagering game server 250 can periodically request a status from all of the wagering game machines 260 in the system 200 to keep track of which wagering game machines are occupied by players (i.e., being used by players to play wagering games), idle and available for game play, or not operational (i.e., out of service). In another example, the wagering game machines 260 are configured to periodically provide status information to the wagering game server 250, or provide status updates to the wagering game server 250 when there is a status change (e.g., when the status changes from “active” or “occupied” to “idle” or “available”). Furthermore, the machine status monitoring unit 258 can determine which of the wagering game machines 260 that are idle have the capabilities for simultaneous game play. For example, the machine status monitoring unit 258 can determine which of the idle wagering game machines have remote login and reservation capabilities and account based wagering capabilities. In one example, to initiate simultaneous game play, the wagering game server 250 may remotely log in to a second wagering game machine based on login information provided by the player at the first wagering game machine 260. The wagering game sever 250 may also remotely reserve the second wagering game machine to prevent other players from logging in to the machine. Also, to initiate simultaneous game play based on the player's wagering system account (e.g., maintained at the wagering game controller 210), the second wagering game machine may need to have account based wagering capabilities to communicate with the wagering game controller 210 to obtain and update the player's account information, as will be further described below. After block 306, the flow continues at block 308.

At block 308, the machine status monitoring unit 258 of the wagering game server 250 provides an indication of the one or more wagering game machines 260 of the system 200 that are idle and available for simultaneous game play to the first wagering game machine 260. The machine status monitoring unit 258 can also provide other information about the wagering game machines 260 that are idle and available for simultaneous game play; e.g., the machine status monitoring unit 258 can indicate the location of the idle wagering game machines within the casino, the games available at each idle wagering game machine, etc. In one example, the machine status monitoring unit 258 can provide a map of the casino floor indicating which of the wagering game machines 260 are idle and available for simultaneous game play, and also the location of the wagering game machines from the player's current location. In some examples, simultaneous game play can be limited to idle wagering game machines that are adjacent to, or in close proximity to, the first wagering game machine 260. It is noted, however, that in other embodiments the machine status monitoring unit 258 can inform the first wagering game machine 260 of the wagering game machines 260 that are idle and available for simultaneous game play by other methods. For example, the machine status monitoring unit 258 can provide information (e.g., list of available games) associated with the idle wagering game machines without showing the location, initiate a lighting presentation in adjacent wagering game machines that are idle and available for simultaneous game play, etc.

The wagering game server 250 receives selection information indicating a second wagering game machine 260 that the player selected for simultaneous game play from the first wagering game machine 260. Also, the wagering game server 250 receives player verification information (e.g., login information, account number, player ID number, or password) from the first wagering game machine 260 for initiating simultaneous game play in the first and second wagering game machines 260 based on the player's wagering game system account. After block 308, the flow continues at block 310.

At block 310, the wagering game server 250 locks the second wagering game machine 260, selected by player from the wagering game machines that are idle and available for simultaneous game play, and causes the second wagering game machine 260 to display an indication that the machine is reserved for simultaneous game play. In one embodiment, the simultaneous gaming unit 256 locks or temporarily deactivates the control panel, touchscreen, and other input devices of the second wagering game machine 260 (e.g., buttons, joystick, card reader, etc.). The simultaneous gaming unit 256 may also turn off the lights illuminating the buttons, card reader, etc. of the second wagering game machine 260. The simultaneous gaming unit 256 may also cause the second wagering game machine 260 to display an indication that the second wagering game machine 260 is reserved. For example, the second wagering game machine 260 can display a “reserved” status message in one or more displays of the machine. It is noted, however, that the simultaneous gaming unit 256 can cause the second wagering game machine 260 to provide other indications that the machine is reserved, e.g., remove the game menus from the display, dim or turn off all the lights of the machine, etc. In some embodiments, even though the second wagering game machine 260 provides various indications that the machine is reserved, the wagering games that are played during simultaneous game play can be displayed on the second wagering game machine 260. However, the account balance and other player information are not displayed on the second wagering game machine 260 for privacy considerations. Locking the second wagering game machine 260 and/or providing one or more indications that the second wagering game machine 260 is reserved prevents another player from disrupting a simultaneous game play session by attempting to log in to the second wagering game machine. After block 310, the flow continues at block 312.

At block 312, the wagering game server 250 initiates a wagering game session for the player at the second wagering game machine based on the player's wagering game system account. For example, the simultaneous gaming unit 256, in conjunction with the game management unit 252, accesses the account server 270 to determine the wagering game system account associated with the player based on the received player verification information. The simultaneous gaming unit 256 ties the player's wagering game system account to both the first and second wagering game machines 260 to deduct wager amounts, and credit win amounts, to the player's account balance based on the game activity associated with both the first and second wagering game machines 260 during simultaneous game play. After block 312, the flow continues at block 314.

At block 314, the wagering game server 250 initiates simultaneous game play in the first and second wagering game machines 260. In one embodiment, when the second wagering game machine 260 is adjacent to, or in close proximity to, the first wagering game machine 260 (i.e., the location of the player), the first wagering game machine 260 can present a first wagering game (e.g., a video slots game) on the display of the first wagering game machine 260, and a second wagering game (e.g., another video slots game) on the display of the second wagering game machine 260. As described above with reference to FIG. 1, the simultaneous gaming unit 256 of the wagering game server 250 can allow the player to begin simultaneous game play, i.e., play both the first wagering game and the second wagering game simultaneously from the first wagering game machine 260. For example, the simultaneous gaming unit 256 can detect the player input for the first wagering game entered at first wagering game machine 260, and the simultaneous gaming unit 256 can then apply the same player input to the second wagering game associated with the second wagering game machine 260 for synchronized game play. In one example, if the player presses the spin button at the first wagering game machine 260 to spin the reels of a first slots game, the simultaneous gaming unit 256 can trigger a spin of the reels of a second slots game being displayed at the second wagering game machine 260. In another example, the simultaneous gaming unit 256 waits to spin the reels of the second slots game displayed at the second wagering game machine 260 until the reels of the first slots game stop spinning and show the results. In another example, instead of synchronized game play, the simultaneous gaming unit 256 can cause the first wagering game machine 260 to present a control panel on the display of the first wagering game machine 260 that separately controls the second wagering game on the second wagering game machine 260. In some examples, when the reserved wagering game machine is not in close proximity to the first wagering game machine 260, the simultaneous gaming unit 256 can cause first wagering game machine 260 to present a window within one of the displays of the first wagering game machine 260 to display the second wagering game associated with the second wagering game machine 260 being played during simultaneous game play. In some embodiments, if the player initiates simultaneous game play on two adjacent wagering game machines 260, the simultaneous gaming unit 256 can extend the wagering game displayed on the first wagering game machine 260 to include the game content displayed on the second wagering game machine 260. For example, the simultaneous gaming unit 256 can extend two 5 reel slots games displayed at the two adjacent wagering game machines 260 across the two adjacent machines to allow the player to play a 10 reel slots game. During simultaneous game play, the wager amounts and the win amounts for both the first and second wagering games can be deducted from and added to, respectively, the account balance associated with the player's wagering game system account.

In some embodiments, the machine status monitoring unit 258 of the wagering game server 250 can detect the number of wagering game machines that are idle and available for simultaneous game play, and then determine what is the percentage of the total wagering game machines in the casino that are idle and available for simultaneous game play. If the percentage is below a low threshold, the machine status monitoring unit 258 can determine that the casino is close to full capacity. In one example, when the casino is close to full capacity, the simultaneous gaming unit 256 may not allow players to initiate simultaneous game play to keep at least a certain number of wagering game machines available for other players. In another example, when the casino is close to full capacity, the simultaneous gaming unit 256 may allow a player to initiate simultaneous game play if the player wagers a maximum bet amount during each game, or wagers at least the average wager amount for that type of game. In another example, the simultaneous gaming unit 256 can allow players to initiate simultaneous game play if they play wagering games at a certain pace during simultaneous game play (e.g., at least 2 games every minute of a slots game). If the players do not meet the specified requirements (e.g., wager at least an average wager amount), the simultaneous gaming unit 256 can end simultaneous game play and the player forfeits the extra wagering game machine(s). In other words, the extra wagering game machines are made available to other players. Similarly, the machine status monitoring unit 258 can track the percentage of certain types of wagering game machines that are available for simultaneous game play to determine whether to place restrictions on simultaneous game play using those types of machines.

In some embodiments, if an adjacent wagering game machine is occupied, the wagering game server 250 can allow players to indirectly play on the occupied, adjacent machine during simultaneous game play by placing a wager on the outcome of the games the other player plays on the adjacent machine. In other words, at the same time that the player plays a wagering game at a first wagering game machine, the player can also wager on the outcome of games that other players are playing in one or more adjacent wagering game machines.

In some embodiments, if a call attendant for a hand pay is triggered at the first wagering game machine 260 during simultaneous game play, the wagering game server 250 allows the player to continue playing the wagering games associated with the second wagering game machine 260 while the player waits for the hand pay. In another example, the wagering game server 250 may allow a player to initiate simultaneous game play functionality when a hand pay is triggered at the first wagering game machine 260, so that the player continues to play wagering games at a second wagering game machine while the player waits for the hand pay. In another example, if a call attendant for a hand pay is triggered at the first wagering game machine 260 during simultaneous game play, the wagering game server 250 can allow the player to transfer the call attendant for the hand pay to the second wagering game machine 260 so that the player can continue playing the wagering games associated with the first wagering game machine 260 while the player waits for the hand pay.

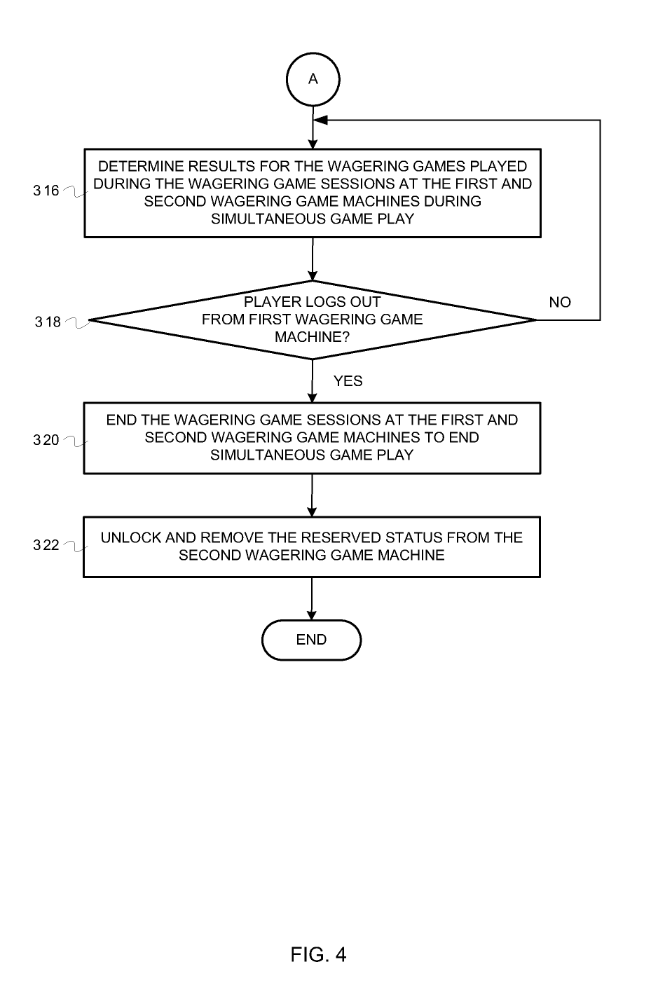

In some embodiments, the wagering game server 250 can offer incentives to players to initiate simultaneous game play in the system 200. For example, the simultaneous gaming unit 256 can provide a player that has initiated simultaneous game play in two wagering game machines double the chances to win a progressive, or a bonus award when the player wins. In another example, players that initiate simultaneous game play can be eligible to win a progressive reserved exclusively for players that participate in simultaneous game play. After block 314, the flow continues at block 316 of FIG. 4.

FIG. 4 is a flow diagram illustrating additional operations of a wagering game server for implementing simultaneous game play in two or more wagering game machines of a wagering game system, according to some embodiments. The flow shown in FIG. 4 is a continuation of the flow 300 shown in FIG. 3. The flow diagram begins at block 316.

At block 316, the wagering game server 250 determines the results for the wagering games played during the wagering game sessions at the first and second wagering game machines during simultaneous game play. In one embodiment, the simultaneous gaming unit 256, in conjunction with the game management unit 252, can determine the results of the wagering games played at the first and second wagering game machines during simultaneous game play. As was described above, the player's wagering game system account can be updated based on the results (e.g., win amounts) of the wagering games played at the first and second wagering game machines. In one example, the game management unit 252 can determine the results of the wagering games played at the first and second wagering game machines, and the simultaneous gaming unit 256 can update the player's wagering game system account based on the results. After block 316, the flow continues at block 318.

At block 318, the wagering game server 250 determines whether the player logs out from the first wagering game machine 260. For example, the game management unit 252 receives an indication from the first wagering game machine 260 to determine when the player logs out from the first wagering game machine 260. The first wagering game machine 260 can detect when the player logs out by various methods, such as detecting when the player removes the player card from the card reader, when the player clicks on an icon or presses a button on the first wagering game machine 260, when the player walks away (e.g., using machine vision), etc. If the player logs out, the flow continues at block 320. Otherwise, the flow loops back to block 316, where the wagering game server 316 continues to determine results of the wagering games the player plays during simultaneous game play player.

At block 320, the wagering game server 250 ends the wagering game sessions at the first and second wagering game machines 260. In one embodiment, in response to receiving an indication from the game management unit 252 when the player logs out from the first wagering game machine 260, the simultaneous gaming unit 256 can end the wagering game sessions at the first and second wagering game machines 260. It is noted, however, that in some situations the player may provide input at the first wagering game machine 260 that indicates only to log out from the second wagering game machine 260 to end simultaneous game play. In this case, the simultaneous gaming unit 256 may end the wagering game session at the second wagering game machine 260 (and therefore end simultaneous game play), but the player may continue playing at the first wagering game machine 260. After block 320, the flow continues at block 322.

At block 322, the wagering game server 250 unlocks and removes the reserved status from the second wagering game machine 260. For example, after simultaneous game play is ended, the simultaneous gaming unit 256 unlocks the second wagering game machine 260 and removes all indications that the second wagering game machine 260 is reserved, so that the machine is available for other players. After block 322, the flow ends.

FIG. 5 is a flow diagram (“flow”) 500 illustrating operations for remote reservation of one or more wagering game machines in a wagering game system, according to some embodiments. The flow of 500 will be described with reference to the example system architecture of FIG. 2. The flow diagram begins at block 502.

At block 502, the wagering game server 250 initiates a wagering game session for a player at a first wagering game machine 260 of the wagering game system 200 based on a wagering game system account associated with the player. In one embodiment, the game management unit 252 of the wagering game server 250 receives login information (e.g., wagering game system account number, player ID number, and/or passwords) from the first wagering game machine 260 (similarly as was described above with reference to FIGS. 1 and 3), and initiates the wagering game session for the player. After block 502, the flow continues at block 504.

At block 504, the wagering game server 250 detects an indication that the player at the first wagering game machine 260 wants to remotely reserve another wagering game machine 260. The simultaneous gaming unit 256 of the wagering game server 250 can allow the player at the first wagering game machine 260 to remotely reserve another wagering game machine 260 to move to a different section of the casino, to try different wagering games only available in certain wagering game machines in the casino, etc. In one example, the first wagering game machine 260 receives player input indicating that the player wants to remotely reserve another wagering game machine 260. The first wagering game machine 260 then sends a message to inform the wagering game server 250. After block 504, the flow continues at block 506.

At block 506, the wagering game server 250 identifies one or more wagering game machines 260 in the wagering game system 200 that are idle and available to be reserved. For example, similarly as was described above with reference to FIG. 3, the machine status monitoring unit 258 can periodically obtain status information from the wagering game machines 260, or receive status updates from the wagering game machines 260 when there is a status change (e.g., when the status changes from “active” or “occupied” to “idle” or “available”). After block 506, the flow continues at block 508.

At block 508, the machine status monitoring unit 258 provides an indication of the one or more wagering game machines 260 of the system 200 that are idle and available to be reserved to the first wagering game machine 260. Also, similarly as was described above with reference to FIG. 3, the machine status monitoring unit 258 can also provide other information about the wagering game machines 260 that are idle; e.g., the machine status monitoring unit 258 can indicate the location of the idle wagering game machines within the casino (e.g., using a map of the casino floor), the games available at each idle wagering game machine, etc.

The wagering game server 250 receives selection information indicating a second wagering game machine 260 that the player wants to remotely reserve from the first wagering game machine 260. Also, the wagering game server 250 receives player verification information (e.g., login information, account number, player ID number, or password) from the first wagering game machine 260 for reserving the second wagering game machine 260. After block 508, the flow continues at block 510.

At block 510, the wagering game server 250 reserves a second wagering game machine 260 selected by the player from the wagering game machines that are idle and available to be reserved. For example, the simultaneous gaming unit 256 causes the second wagering game machine 260 to display an indication that the machine is reserved, similarly as was described above with reference to FIG. 3. In one example, when a player attempts to log in to the reserved second wagering game machine 260, a window or other notification screen may be presented requesting the player to enter verification information (e.g., login information). After block 510, the flow continues at block 512.

At block 512, the wagering game server 250 starts a timer to give the player a predefined amount of time to log in at the reserved second wagering game machine 260. In one example, the simultaneous gaming unit 256 can start the timer immediately after the player reserves the second wagering game machine 260 from the first wagering game machine 260. In this example, the player will have the predefined amount of time associated with the timer to log off from the first wagering game machine 260, find the second wagering game machine 260, and initiate the login procedure at the second wagering game machine 260 before the timer expires or the player will forfeit the reservation of the machine. It is noted, however, that in other embodiments the amount of time that the player is given to log in to the reserved machine may vary depending on whether the casino is close to full capacity, or whether there are sufficient idle machines available for the number of players in the casino. In other words, the timer may be set to a time value from a predefined range of time values depending on the number of players in the casino. The more players that are detected in the casino, the less time the player will be given to log in to the reserved machine (and vice versa). After block 512, the flow continues at block 514.

At block 514, the wagering game server 250 initiates a wagering game session at the reserved second wagering game machine 260 after verifying that the received login information is associated with the player that reserved the machine. In one example, the game management unit 252 receives login information from the reserved second wagering game machine 260 and communicates with the account server 270 to verify that the login information is associated with player that reserved the machine. If the login information is verified, the game management unit 252 initiates the wagering game session for the player at the reserved second wagering game machine 260. After block 514, the flow ends.

In some embodiments, when a player has initiated simultaneous game play at two or more wagering game machines (e.g., as described above with reference to FIGS. 1 and 3-4), the wagering game server 250 can allow the player to remotely reserve two or more different wagering game machines if the player wants to move to different machines or to a different section of the casino. In addition to reserving the wagering game machines, the wagering game server 250 can allow the player to transfer the wagering game sessions associated with simultaneous game play to the reserved wagering game machines so that the player can continue the current wagering game sessions at the reserved wagering game machines. In some examples, to transfer the wagering game sessions, the wagering game server 250 can transfer the game configurations, game content, simultaneous game play configurations and status, and other game or player related information associated with the current wagering game sessions to the reserved wagering game machines. This can allow players to move from one set of wagering game machines to another set of wagering game machines without ending the wagering game sessions associated with the simultaneous game play session.

In some embodiments, the wagering game server 250 can allow a player to initiate simultaneous game play at the wagering game machine 160B based on money deposited at a first wagering game machine 260 (e.g., via a ticket, cash, debit card, etc.). In other words, instead of initiating simultaneous game play based on account based wagering capabilities, the wagering game server 250 can initiate simultaneous game play at the first and second wagering game machines 260 based on a monetary deposit at the first wagering game machine 260. In some embodiments, in both the account based wagering examples and in the non-account based wagering example, the wagering game server 250 can allow two different players to play at two different machines using the same simultaneous gaming mechanism based on the same account or one-time monetary deposit, as long as the second player enters verification information in the second wagering game machine that ensures the second player has authorization from first player. In some embodiments, the operator of the wagering game system (e.g., the casino operator) can initiate a promotional account that can be accessed by players that initiate simultaneous game play to promote the simultaneous game play functionality, or to promote a new game, product, or service. For example, to encourage players to try a simultaneous game play session (or to promote a product or service), each player can access the promotional account during the simultaneous game play session and have 5 free spins.

### Additional Example Operating Environments

This section describes example operating environments, systems and networks, and presents structural aspects of some embodiments.

### Wagering Game Machine Architecture

FIG. 6 is a conceptual diagram that illustrates an example of a wagering game machine architecture 600, according to some embodiments. In FIG. 6, the wagering game machine architecture 600 includes a wagering game machine 606, which includes a central processing unit (CPU) 626 connected to main memory 628. The CPU 626 can include any suitable processor, such as an Intel® Pentium processor, Intel® Core 2 Duo processor, AMD Opteron™ processor, or UltraSPARC processor. The main memory 628 includes a wagering game unit 632. In some embodiments, the wagering game unit 632 can present wagering games, such as video poker, video black jack, video slots, video lottery, reel slots, etc., in whole or part. The wagering game unit 632 may also facilitate simultaneous game play and remote reservation in a wagering game system, e.g., as described above with reference to FIGS. 1-5.

The CPU 626 is also connected to an input/output (“I/O”) bus 622, which can include any suitable bus technologies, such as an AGTL+ frontside bus and a PCI backside bus. The I/O bus 622 is connected to a payout mechanism 608, primary display 610, secondary display 612, value input device 614, player input device 616, information reader 618, and storage unit 630. The player input device 616 can include the value input device 614 to the extent the player input device 616 is used to place wagers. The I/O bus 622 is also connected to an external system interface 624, which is connected to external systems 604 (e.g., wagering game networks). The external system interface 624 can include logic for exchanging information over wired and wireless networks (e.g., 802.11g transceiver, Bluetooth transceiver, Ethernet transceiver, etc.)

The I/O bus 622 is also connected to a location unit 638. The location unit 638 can create player information that indicates the wagering game machine's location/movements in a casino. In some embodiments, the location unit 638 includes a global positioning system (GPS) receiver that can determine the wagering game machine's location using GPS satellites. In other embodiments, the location unit 638 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location. Although not shown in FIG. 6, in some embodiments, the location unit 638 is not connected to the I/O bus 622.

In some embodiments, the wagering game machine 606 can include additional peripheral devices and/or more than one of each component shown in FIG. 6. For example, in some embodiments, the wagering game machine 606 can include multiple external system interfaces 624 and/or multiple CPUs 626. In some embodiments, any of the components can be integrated or subdivided.

In some embodiments, the wagering game machine 606 includes an online gaming module 637. The online gaming module 637 can process communications, commands, or other information, where the processing can control and present online wagering games. In some embodiments, the online gaming module 637 can work in concert with the wagering game unit 632, and can perform any of the operations described above.

Furthermore, any component of the wagering game machine 606 can include hardware, firmware, and/or machine-readable storage media including instructions for performing the operations described herein.

### Example Wagering Game Machines

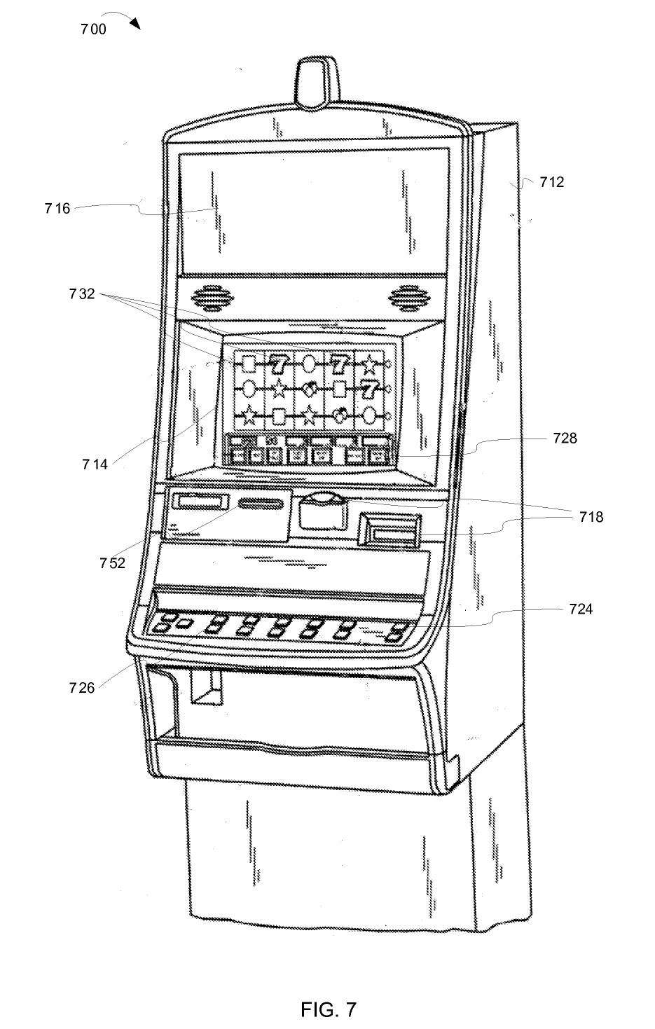

FIG. 7 is a perspective view of a wagering game machine, according to example embodiments. Referring to FIG. 7, a wagering game machine 700 is used in gaming establishments, such as casinos. In some embodiments, the wagering game machine 700 can facilitate simultaneous game play and remote reservation in a wagering game system, as was described above in FIGS. 1-6.

According to embodiments, the wagering game machine 700 can be any type of wagering game machine and can have varying structures and methods of operation. For example, the wagering game machine 700 can be an electromechanical wagering game machine configured to play mechanical slots, or it can be an electronic wagering game machine configured to play video casino games, such as blackjack, slots, keno, poker, blackjack, roulette, etc.

The wagering game machine 700 comprises a housing 712 and includes input devices, including value input devices 718 and a player input device 724. For output, the wagering game machine 700 includes a primary display 714 for displaying information about a basic wagering game. In some implementations, the primary display 714 can also display information about a bonus wagering game and a progressive wagering game. The wagering game machine 700 also includes a secondary display 716 for displaying bonus wagering games, wagering game events, wagering game outcomes, and/or signage information. While some components of the wagering game machine 700 are described herein, numerous other elements can exist and can be used in any number or combination to create varying forms of the wagering game machine 700.

The value input devices 718 can take any suitable form and can be located on the front of the housing 712. The value input devices 718 can receive currency and/or credits inserted by a player. The value input devices 718 can include coin acceptors for receiving coin currency and bill acceptors for receiving paper currency. Furthermore, the value input devices 718 can include ticket readers or barcode scanners for reading information stored on vouchers, cards, or other tangible portable storage devices. The vouchers or cards can authorize access to central accounts, which can transfer money to the wagering game machine 700.

The player input device 724 comprises a plurality of push buttons on a button panel 726 for operating the wagering game machine 700. In addition, or alternatively, the player input device 724 can comprise a touch screen 728 mounted over the primary display 714 and/or secondary display 716.

The various components of the wagering game machine 700 can be connected directly to, or contained within, the housing 712. Alternatively, some of the wagering game machine's components can be located outside of the housing 712, while being communicatively coupled with the wagering game machine 700 using any suitable wired or wireless communication technology.

The operation of the basic wagering game can be displayed to the player on the primary display 714. The primary display 714 can also display a bonus game associated with the basic wagering game. The primary display 714 can include a cathode ray tube (CRT), a high resolution liquid crystal display (LCD), a plasma display, light emitting diodes (LEDs), or any other type of display suitable for use in the wagering game machine 700. Alternatively, the primary display 714 can include a number of mechanical reels to display the outcome. In FIG. 7, the wagering game machine 700 is an “upright” version in which the primary display 714 is oriented vertically relative to the player. Alternatively, the wagering game machine can be a “slant-top” version in which the primary display 714 is slanted at about a thirty-degree angle toward the player of the wagering game machine 700. In yet another embodiment, the wagering game machine 700 can exhibit any suitable form factor, such as a free standing model, bartop model, mobile handheld model, or workstation console model.

A player begins playing a basic wagering game by making a wager via the value input device 718. The player can initiate play by using the player input device's buttons or touch screen 728. The basic game can include arranging a plurality of symbols along a payline 732, which indicates one or more outcomes of the basic game. Such outcomes can be randomly selected in response to player input. At least one of the outcomes, which can include any variation or combination of symbols, can trigger a bonus game.

In some embodiments, the wagering game machine 700 can also include an information reader 752, which can include a card reader, ticket reader, bar code scanner, RFID transceiver, or computer readable storage medium interface. In some embodiments, the information reader 752 can be used to award complimentary services, restore game assets, track player habits, etc.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A computer-implemented method comprising:
initiating a wagering game session for a player in a first wagering game machine of a wagering game system based on a wagering game system account associated with the player;
determining whether to initiate simultaneous game play for the player in the wagering game system;
identifying one or more wagering game machines of the wagering game system that are idle and available for simultaneous game play, in response to determining to initiate simultaneous game play for the player;
initiating a wagering game session for the player in a second wagering game machine of the wagering game system for simultaneous game play, wherein the second wagering game machine is selected from the one or more wagering game machines that are idle and available for simultaneous game play; and
initiating simultaneous game play in the first and second wagering game machines based on the player's wagering game system account.

2. The method of claim 1, further comprising:
determining results of the wagering games played during the wagering game sessions associated with the first and second wagering game machines during simultaneous game play; and
updating the player's wagering game system account based on the results of the wagering games played during the wagering game sessions associated with the first and second wagering game machines during simultaneous game play.

3. The method of claim 2, further comprising causing the first wagering game machine to present the results of the wagering games played during the wagering game sessions associated with the first and second wagering game machines during simultaneous game play.

4. The method of claim 1, wherein said identifying one or more wagering game machines of the wagering game system that are idle and available for simultaneous game play comprises:
determining status information associated with each of the wagering game machines of the wagering game system; and
identifying one or more wagering game machines of the wagering game system that are idle and available for simultaneous game play based, at least in part, on the status information associated with each of the wagering game machines of the wagering game system.

5. The method of claim 1, wherein said initiating the wagering game session for the player in the second wagering game machine for simultaneous game play comprises:
determining that the player selected the second wagering game machine from the one or more wagering game machines that were identified as idle and available for simultaneous game play;
verifying an identity of the player based, at least in part, on login information entered by the player;
locking the second wagering game machine to prevent other players from gaining access to the second wagering game machine during simultaneous game play; and
causing the second wagering game machine to present wagering game content to initiate the wagering game session in the second wagering game machine for simultaneous game play.

6. The method of claim 5, further comprising, in addition to causing the first wagering game machine to present wagering game content for the wagering game session associated with the first wagering game machine, causing the first wagering game machine to present wagering game content for the wagering game session associated with the second wagering game machine for simultaneous game play.

7. The method of claim 1, wherein said initiating simultaneous game play in the first and second wagering game machines based on the player's wagering game system account comprises:
obtaining account information associated with the player's wagering game system account; and
associating both the wagering game session on the first wagering game machine and the wagering game session on the second wagering game machine to the player's wagering game system account during simultaneous game play.

8. The method of claim 7, wherein said associating both the wagering game session on the first wagering game machine and the wagering game session on the second wagering game machine to the player's wagering game system account during simultaneous game play comprises:
coordinating deductions of wager amounts for the wagering games played that are associated with both the first and second wagering game machines from an account balance associated with the player's wagering game system account; and
coordinating credits of win amounts for the wagering games played that are associated with both the first and second wagering game machines from the account balance associated with the player's wagering game system account.

9. The method of claim 1, further comprises coordinating simultaneous game play in the first and second wagering game machines, wherein said coordinating simultaneous game play comprises:
detecting input from the player to trigger a start of a round of a wagering game associated with the first wagering game machine; and
causing the first wagering game machine to start the round of the wagering game associated with the first wagering game machine and simultaneously causing the second wagering game machine to start a round of a wagering game associated with the second wagering game machine.

10. The method of claim 1, further comprising:
determining when the player logs off the first wagering game machine; and
ending the wagering game session associated with the first wagering game machine and the wagering game session associated with the second wagering game machine in response to determining that the player logs off the first wagering game machine.

11. The method of claim 1, further comprising:
determining whether a number of wagering game machines in the wagering game system that are idle and available for simultaneous game play is above a threshold that indicates whether sufficient idle wagering game machines are available for other players;
allowing simultaneous game play if the number of wagering game machines that are idle and available for simultaneous game play is greater than the threshold; and
preventing simultaneous game play if the number of wagering game machines that are idle and available for simultaneous game play is equal to or less than the threshold.

12. The method of claim 1, further comprising:
determining that a call attendant notification for a hand pay has been triggered at the first wagering game machine during simultaneous game play associated with the first wagering game machine and the second wagering game machine, wherein the second wagering game machine is located adjacent to the first wagering game machine;
transferring the call attendant notification for the hand pay from the first wagering game machine to the second wagering game machine;
causing the first wagering game machine and the second wagering game machine to pause the wagering game session associated with the second wagering game machine to wait for the hand pay; and
allowing the first wagering game machine to continue the wagering game session associated with the first wagering game machine while the player waits for the hand pay.

13. The method of claim 1, further comprising causing the first wagering game machine to present a map of the wagering game system indicating which of the wagering game machines in the wagering game system are idle and available for simultaneous game play, and a location of the wagering game machines within the wagering game system with respect to a location of the first wagering game machine.

14. A wagering game server comprising:
means for initiating a wagering game session for a player in a first wagering game machine of a wagering game system based on a wagering game system account associated with the player;
means for determining that the player wants to initiate simultaneous game play in the wagering game system;
means for identifying one or more wagering game machines of the wagering game system that are idle and available for simultaneous game play;
means for initiating a wagering game session for the player in a second wagering game machine of the wagering game system for simultaneous game play, wherein the second wagering game machine is selected from the one or more wagering game machines that are idle and available for simultaneous game play; and
means for initiating simultaneous game play in the first and second wagering game machines based on the player's wagering game system account.

15. The wagering game server of claim 14, further comprising:
means for determining results of the wagering games played during the wagering game sessions associated with the first and second wagering game machines during simultaneous game play; and
means for updating the player's wagering game system account based on the results of the wagering games played during the wagering game sessions associated with the first and second wagering game machines during simultaneous game play.

16. The wagering game server of claim 14, wherein said means for initiating the wagering game session for the player in the second wagering game machine for simultaneous game play comprises:
means for determining that the player selected the second wagering game machine from the one or more wagering game machines that were identified as idle and available for simultaneous game play;
means for verifying an identity of the player based, at least in part, on login information entered by the player;
means for locking the second wagering game machine to prevent other players from gaining access to the second wagering game machine during simultaneous game play;
means for causing the second wagering game machine to present wagering game content to initiate the wagering game session in the second wagering game machine for simultaneous game play; and
means for causing the first wagering game machine to present wagering game content for the wagering game session associated with the first wagering game machine and present wagering game content for the wagering game session associated with the second wagering game machine for simultaneous game play.

17. A computer-implemented method comprising:
initiating a wagering game session for a player in a first wagering game machine of a wagering game system based on a wagering game system account associated with the player;
determining that the player wants to remotely reserve at least one wagering game machine of the wagering game system;
identifying one or more wagering game machines of the wagering game system that are idle and available to be reserved;
determining that the player wants to remotely reserve a second wagering game machine selected by the player from the one or more wagering game machines of the wagering game system that are idle and available to be reserved;
reserving the second wagering game machine for the player; and
starting a timer providing the player a predefined amount of time to log in to the second wagering game machine that is reserved for the player.

18. The method of claim 17, further comprising:
determining whether the player logs in to the second wagering game machine that is reserved for the player before the predefined amount of time associated with the timer expires;
if the player logs in before the predefined amount of time associated with the time expires, initiating a wagering game session for the player at the second wagering game machine based on the player's wagering game system account; and
if the player does not log in before the predefined amount of time associated with the time expires, changing a status of the second wagering game machine from reserved to available to allow other players to log in to the second wagering game machine.

19. The method of claim 17, further comprising causing the first wagering game machine to present a map of the wagering game system indicating which of the wagering game machines in the wagering game system are idle and available to be reserved, and a location of the wagering game machines within the wagering game system with respect to a location of the first wagering game machine.

20. A wagering game system comprising:
a first wagering game machine;
a second wagering game machine; and
a wagering game server coupled to the first and second wagering game machines via a communications network, the wagering game server configured to initiate a wagering game session for a player in the first wagering game machine based on a wagering game system account associated with the player, and configured to:
determine whether to initiate simultaneous game play for the player in the wagering game system;
identify one or more wagering game machines of the wagering game system that are idle and available for simultaneous game play, in response to determining to initiate simultaneous game play for the player;
initiate a wagering game session for the player in the second wagering game machine for simultaneous game play, wherein the second wagering game machine is selected from the one or more wagering game machines that are idle and available for simultaneous game play; and
initiate simultaneous game play in the first and second wagering game machines based on the player's wagering game system account;
wherein, during simultaneous game play, the first wagering game machine is configured to present game content for wagering games played during the wagering game session associated with the first wagering game machine, and present wagering game content for wagering games played during the wagering game session associated with the second wagering game machine; and
wherein, during simultaneous game play, the second wagering game machine is configured to present game content for wagering games played during the wagering game session associated with the second wagering game machine.

21. The wagering game system of claim 20, wherein the wagering game server is further configured to:
determine results of the wagering games played during the wagering game sessions associated with the first and second wagering game machines during simultaneous game play; and
update the player's wagering game system account based on the results of the wagering games played during the wagering game sessions associated with the first and second wagering game machines during simultaneous game play.

22. The wagering game system of claim 20, wherein the wagering game server configured to initiate simultaneous game play in the first and second wagering game machines based on the player's wagering game system account comprises the wagering game server configured to:
obtain account information associated with the player's wagering game system account; and
associate both the wagering game session on the first wagering game machine and the wagering game session on the second wagering game machine to the player's wagering game system account during simultaneous game play.

23. One or more machine-readable storage media, having instructions stored therein, which, when executed by one or more processors causes the one or more processors to perform operations that comprise:
initiating a wagering game session for a player in a first wagering game machine of a wagering game system based on a wagering game system account associated with the player;
determining that the player wants to initiate simultaneous game play in the wagering game system based, at least in part, on an indication received from the first wagering game machine indicating that the player wants to initiate simultaneous game play;
identifying one or more wagering game machines of the wagering game system that are idle and available for simultaneous game play;
initiating a wagering game session for the player in a second wagering game machine for simultaneous game play, in response to receiving an indication from the first wagering game machine that the player selected the second wagering game machine from the one or more wagering game machines that are idle and available for simultaneous game play; and
initiating simultaneous game play in the first and second wagering game machines based on the player's wagering game system account.

24. The machine-readable storage media of claim 23, wherein said operations further comprise:
determining results of the wagering games played during the wagering game sessions associated with the first and second wagering game machines during simultaneous game play; and
updating the player's wagering game system account based on the results of the wagering games played during the wagering game sessions associated with the first and second wagering game machines during simultaneous game play.

25. The machine-readable storage media of claim 23, wherein said operation for initiating the wagering game session for the player in the second wagering game machine for simultaneous game play comprises:
determining that the player selected the second wagering game machine from the one or more wagering game machines that were identified as idle and available for simultaneous game play;
verifying an identity of the player based, at least in part, on login information entered by the player;
locking the second wagering game machine to prevent other players from gaining access to the second wagering game machine during simultaneous game play;
causing the second wagering game machine to present wagering game content to initiate the wagering game session at the second wagering game machine for simultaneous game play; and
causing the first wagering game machine to present wagering game content for the wagering game session associated with the first wagering game machine and present wagering game content for the wagering game session associated with the second wagering game machine for simultaneous game play.
